(19) United States
(12) Patent Application Publication
(10) Pub. No.: US 2026/0365375 A1
(43) Pub. Date: Nov. 19, 2026

(54) SIDE-GUSSETED PACKAGING BAG AND METHOD FOR PRODUCING A SIDE-GUSSETED PACKAGING BAG

(71) Applicant: MONDI AG, Wien (AT)

(72) Inventor: Jens KÖSTERS, Wallenhorst (DE)

(21) Appl. No.: 19/141,194

(22) PCT Filed: Jan. 4, 2024
(86) PCT No.: PCT/EP2024/050121

§ 371 Date: Jun. 19, 2025

(30) Foreign Application Priority Data
Jan. 27, 2023 (EP) 23153762.2

(51) Int. Cl. B65D 30/20; B29C 65/00; B29L 31/00

(52) U.S. Cl. CPC B65D 31/10; B29C 66/4322; B29C 66/71; B29C 66/8322; B29C 66/8511; B29L 2031/7128

(57) ABSTRACT

The invention relates to a side-gusseted packaging bag comprising a bag body which consists of a first front wall (1a), a second front wall (1b), a first side gusset (2a), and a second side gusset (2b) and which is made of a bag film. A first leaf (6a) of the first side gusset (2a) adjoins the first front wall (1a) at a first bag corner (4a), and a second leaf (6b) of the first side gusset adjoins the second front wall (1b) at a second bag corner (4b). A third leaf (6c) of the second side gusset (2b) adjoins the second front wall (1b) at a third bag corner (4c), and a fourth leaf (6d) of the second side gusset adjoins the first front wall (1a) at a fourth bag corner (4d). The first front wall (1a) and the first leaf (6a) are connected together at the first bag corner (4a) via a longitudinal seal seam (7) in the form of a closure seam. According to the invention, the second front wall (1b) adjoins the second leaf (6b) at the second bag corner (4b) solely via a folding line (5′).

The invention relates to a side-gusseted packaging bag comprising a bag body which consists of a first front wall, a second front wall, a first side gusset, and a second side gusset and which is made of a bag film, wherein a first leaf of the first side gusset adjoins the first front wall at a first bag corner, and a second leaf of the first side gusset adjoins the second front wall at a second bag corner, wherein a third leaf of the second side gusset adjoins the second front wall at a third bag corner, and a fourth leaf of the second side gusset adjoins the first front wall at a fourth bag corner, and wherein the first front wall and the first leaf are connected together at the first bag corner via a longitudinal seal seam in the form of a closure seam.

Within the scope of the invention, the side-gusseted packaging bag can be utilized for various, preferably granular or powdered bulk materials. The side-gusseted packaging bag can, for example, be provided for containers of foodstuffs such as rice, various sugars, pelleted pet food, or various construction products such as sand, mortar, concrete, tile adhesive, cement-based plaster and leveling compounds for walls and floors, or the like. However, the side-gusseted packaging bag can also be provided for other powdered or granular filling materials from the chemical, food, and animal feed sectors. The filling material weight can, for example, be between 1 kg and 25 kg, and the volume of the closed bag body can be between 2.5 l (liters) and 40 l.

In the filled and closed side-gusseted packaging bag, the contents are largely protected from environmental influences and can therefore be stored for extended periods. Depending on requirements, the closed side-gusseted packaging bag can also have a valve, at least one vent, or the like, for example, if gases generated during storage of the contents need to be vented or pressure equalization is necessary.

In the usual way, the side-gusseted packaging bag can be configured with a stand-up base, strip-shaped closure elements for reclosure or other functional units.

The side-gusseted packaging bag is preferably first manufactured as a bag blank, which can then be stored, transported and handled in a flat state with the side gussets inserted between the front walls, for being filled and closed only subsequently-usually at another production site.

Side-gusseted packaging bags of the type described are manufactured industrially in large quantities, so fast production speed, low manufacturing costs, and, especially, efficient use of materials and energy are of particular importance. A so-called longitudinal method is particularly suitable for shaping the bag body, in which the individual side-gusseted packaging bags are generated from a side-gusseted tube formed from a web of bag film running in a production direction.

From an ecological and economic perspective, good recyclability is also desirable in order to be able to produce high-quality products, and especially high-quality recyclates, through recycling.

Recyclability is assessed, for example, by the cyclos-HTP GmbH institute, which also awards a corresponding label.

Widely used side-gusseted packaging bags feature a laminated bag film comprising an outer film made of polyethylene terephthalate (PET) and a heat-sealable inner film made of polyethylene (PE). However, such a design, known for example from EP 2 186 741, has the disadvantage that single-type recycling of the side-gusseted packaging bag is not possible, or only possible with considerable effort.

A generic side-gusseted packaging bag with a single-type bag body is known from EP 2 987 744 B1. The bag film forming the bag body is a laminate of an outer film oriented monoaxially in the direction of production and an unoriented inner film. In particular, the orientation alters the sealing properties of the outer film such that during production of the side-gusseted packaging bag, forming a side-gusseted tube with two front walls and side gussets inserted between them at the bag corners, only the inner film is welded to itself during heat sealing with a heat sealing device, but not the outer film, which is overlapping itself in the region of the side gussets.

This provides a high-quality, single-type side-gusseted packaging bag that is characterized by very good recyclability.

It is the object of the present invention to provide a side-gusseted packaging bag that can be manufactured particularly easily and cost-effectively. Furthermore, a method for producing such a side-gusseted packaging bag is to be specified.

The subject matter of the invention is and the object is achieved by a side-gusseted packaging bag according to claim 1, and a method for producing a side-gusseted packaging bag according to claim 14.

Based on a generic side-gusseted packaging bag, it is therefore provided that the second front wall adjoins the second leaf at the second bag corner solely via a folding line, i.e. there is no longitudinal seal seam.

While a side-gusseted packaging bag of the generic type known from EP 2 987 744 B1 has manufacturing-related longitudinal seal seams at the bag corners, the present invention teaches a different, asymmetrical configuration, for which-as described below-different measures can be provided during production.

According to a preferred configuration of the invention, it is provided that the side-gusseted packaging bag is formed of a single type of material and consists in particular of a polyolefin, particularly preferably polyethylene (PE).

In this context, the term single-type or single type of material is understood to mean, in particular, when the entire bag body is made of plastic from one polymer class, such as polyethylene or polypropylene. It should be noted that the bag film can, in principle, also be made of multiple layers, and the side-gusseted packaging bag can optionally also have functional elements such as spouts, resealable closures, valves, or the like. These elements, too, are expediently made of the same type of material as the bag film.

Thus, if, according to the preferred configuration described, the side-gusseted packaging bag is made of a single-type polyethylene or single-type polypropylene, individual layers of the bag film and/or other functional elements can have different densities, such as ULDPE, LDPE, LLDPE, MDPE, LLMDPE, and HDPE. In principle, the different density classes can also be collected and recycled together, although such a mixture will naturally have material properties that differ from the various individual initial plastics.

Against this background, the bag body can also be formed in a narrower sense from a single type of material, with materials from a relatively narrow density range being provided.

Especially with regard to polyethylene, a distinction between high-density polyethylene (HDPE) and low-density polyethylene (LDPE) can be expedient because, according to Annex 5 of the German Packaging Act of 5 Jun. 2017 (Act on the further development of the separate collection of waste containing recyclable materials near households), this results in different abbreviations and numbers (HDPE, No. 2, and LDPE, No. 4).

Even if the bag film, and preferably the entire side-gusseted packaging bag, is classified as single-type according to the usual criteria, conventional additives and fillers may be provided. These include, for example, pigments, dyes, processing aids, UV stabilizers, inorganic fillers, and the like. The weight fraction of such additives and fillers is preferably less than 10 wt. %, and particularly preferably less than 5 wt. %, based on the total weight of the bag film or the side-gusseted packaging bag, with the remainder being formed by the single-type polymer itself.

Preferably, it is provided that the bag film is formed from the same polymer on a first side, which forms an outer side of the packaging bag, and on a second side, which forms an inner side of the packaging bag, and also has the same or substantially the same sealing properties on both sides. The first side and the second side can be formed from a single material, in particular by extrusion.

This criterion is, of course, met if the bag film altogether is extruded as a single-layer monofilm. A mono-structure can also be achieved by extruding a mono-layer blown film tube and then blocking it to form the bag film, so that the bag film is twice as thick as the wall thickness of the blown film tube.

Even if, according to a variant of the invention, an at least two-layer blown film tube is blocked, the first side and the second side of the bag film are formed from a single material by extrusion. The blocked core layer, then located on the inside of a symmetrical three-layer structure, can also be formed, for example, from a recyclate, including a post-consumer recyclate (PCR), wherein certain disadvantages with regard to mechanical properties and/or purity can be accepted due to the inner and outer covering of the core layer.

Within the scope of the invention, the bag film is preferably formed as an extrusion film. The bag film is then manufactured in a single extrusion or coextrusion process. Lamination and separate manufacture of partial films are then not provided for, resulting in simple production and low costs.

The front walls and the side gussets are preferably formed jointly by folding and sealing a web of the bag film. At the first bag corner, a circumferential closure is then provided by the longitudinal seal seam in the form of a closure seam, while, according to the invention, at least at the second bag corner, there is no longitudinal seal seam but solely a folding line at the transition from the second leaf to the second front wall.

The third bag corner and the fourth bag corner are located on the second side gusset, and these corners can be implemented differently depending on the production method. In particular, within the scope of the invention, it can be provided that solely the first bag corner is provided with the longitudinal seal seam, while all other bag corners are then provided solely with folding lines. As explained further below, longitudinal seal seams can also be provided on the first bag corner and the fourth bag corner, or alternatively also on the first bag corner and the third bag corner, in which case the remaining bag corners solely have a folding line.

In this context, it can be provided, for example, that in a flat state with side gussets folded between the front walls, the longitudinal seal seam at the first bag corner is arranged next to, i.e. outside, the second front wall. By means of a sealing tool, for example heated sealing jaws, a longitudinal seal seam can then be specifically created solely at the first bag corner. In this context, the invention therefore teaches asymmetric manufacturing to a certain extent.

The side gussets each have two leaves adjoining one another via a folding line. In total, there are therefore four leaves, with a first leaf and a second leaf associated with the first side gusset, and a third and a fourth leaf associated with the second side gusset.

In order to be able to generate the longitudinal seal seam at the first bag corner next to the second front wall, as described above, the first front wall can have a greater width than the second front wall. Accordingly, the first leaf is also to be provided with a greater width so that it extends to the edge of the first front wall. It is readily possible for the first front wall to extend beyond the second front wall solely in the region of the first bag corner, with the fourth bag corner then being lying exactly above the third bag corner on the opposite side of the first front wall and solely folding lines being present there.

Alternatively, the first front wall can also extend beyond the second front wall in the region of the fourth bag corner, allowing a longitudinal seal seam to be easily generated at the fourth bag corner as well. Although this longitudinal seal seam is not required as a closure seam, it can be expedient for esthetic or functional reasons, for example, to increase the stability of the side-gusseted packaging bag.

According to an alternative approach, in the flat state, the front walls can also be offset from one another so that even when the front walls are of the same width, the longitudinal seal seam on the first bag corner is arranged next to, i.e. outside, the second front wall.

With such an offset, the third bag corner protrudes laterally from the first front wall on the opposite side of the second front wall, so that optionally only a folding line is provided on the third bag corner, or a longitudinal seal seam can also be generated. The described offset of the two front walls can be achieved by the first and third leaves having a greater width than the second and fourth leaves.

The overhang produced by a larger width of the first front wall and/or an offset is preferably in a range between 5 mm and 20 mm, in particular between 7 mm and 15 mm.

The side-gusseted packaging bag usually has partial or full-surface printing, wherein, in particular, decoration and/or product information may be provided. Since the bag film is preferably formed entirely as an extrusion film by extrusion or coextrusion, printing is typically applied in high-quality printing on the first side of the bag film, which forms the outside of the bag body. If the bag film is transparent, printing on the second side of the bag film is also generally possible, wherein, in this case, the print is in direct contact with the contents, which can be disadvantageous in many cases. The print applied to the bag film can also be provided with a protective varnish.

According to a refinement of the invention, printing inks and varnishes can also be provided that can be washed off, for example, with water or a suitable solvent. However, printing inks and varnishes are then expediently selected such that they are only removed during a recycling process and cannot dissolve during normal handling of the side-gusseted packaging bag. This requirement can be achieved, for example, by ensuring that removal is only possible with a specific solvent and/or a certain exposure time.

In particular, if the bag film according to a preferred configuration of the invention is formed from single-type polyolefin and particularly preferably from polyethylene, the thickness of the bag film is typically in a range between 80 μm and 250 μm, in particular between 120 μm and 200 μm.

According to the invention, there is at least one bag corner with a longitudinal seal seam, and at least one bag corner without a longitudinal seal seam.

The at least one longitudinal seal seam reinforces the bag body in a manner known per se. Even with solely one longitudinal seal seam, a significant improvement in stability is achieved compared to folding lines at all four bag corners. It is accepted in this case that the film sections incorporated into the corresponding longitudinal seal seam cannot contribute to the formation of the interior space of the bag body. In a sense, the bag body has different dimensions inside and outside in the region of the at least one longitudinal seal seam.

On the other hand, at least one of the bag corners does not have a longitudinal seal seam, wherein then the interior space of the bag body is not reduced there as previously described and efficient utilization results in relation to the material utilized. Within the scope of the invention, in combination, sufficient stability can be achieved together with good material utilization.

The arrangement of at least one bag corner with a longitudinal seal seam and at least one bag corner without a longitudinal seal seam can also be advantageous in the esthetic design of the side-gusseted packaging bag. If, for example, one of the two front walls is delimited by longitudinal seal seams, this front wall can form a front side with a high-quality decorative print. The longitudinal seal seams then stabilize this front side in particular, making it comparatively flat and smooth.

The subject matter of the invention also relates to a method for producing the side-gusseted packaging bag described above, wherein, successively, first, a bag film is formed solely of one type of material in an extrusion process, second, a web of the bag film is folded into a side-gusseted tube having a first front wall, a second front wall, a first side gusset folded in between the front walls and a second side gusset folded in between the front walls in such a way that a first side of the bag film forms an outer side and a second side of the bag film forms an inner side of the side-gusseted tube and that edges of the web lie one above the other at a first side-gusseted tube corner and there the first front wall and the first side gusset are initially not connected, and, third, the side-gusseted tube is closed circumferentially at the first side-gusseted tube corner by a longitudinal seal seam connecting the edges, thus connecting the first front wall to the first side gusset, while, at a second side-gusseted tube corner, a transition from the first side gusset to the second front wall remains in the form of a folded edge.

As also described in connection with the previously described side-gusseted packaging bag itself, in the method according to the invention the front walls on the side-gusseted tube can be formed with different widths and/or offset to one another in such a way that the longitudinal seal seam connecting the first side gusset and the first front wall is formed laterally next to the second front wall.

Alternatively, it is possible for the second side-gusseted tube corner to be guided past a sealing tool that generates the longitudinal seal seam by means of a deflection unit. Initially, the side-gusseted tube is usually supported in a flat state on an even surface. In order to selectively seal only the first side-gusseted tube corner and not the second side-gusseted tube corner, the second side-gusseted tube corner can, for example, be deflected downward and guided past the sealing tool so that the sealing tool does not engage with the second side-gusseted tube corner. Furthermore, it is also possible to temporarily fold the second side-gusseted tube corner inward, wherein usually the generation of further clearly defined folding lines is to be avoided. According to a further alternative configuration of the invention, it is provided that, when producing the longitudinal seal seam, the first side-gusseted tube corner and the second side-gusseted tube corner lie one above the other, wherein a sealing tool is used to generate a temperature gradient across a thickness of the side-gusseted tube, which temperature gradient only effects a permanent connection at the first side-gusseted tube corner.

For example, it can be provided that the sealing tool has a heated sealing jaw at the first side-gusseted tube corner, wherein a counter element of the sealing tool bearing against the second side-gusseted tube corner is unheated or even cooled. The counter element may, for example, have a rubber coating or be made of rubber. It is also possible in this case for the counter element to be wider than the heated sealing jaw in order to counteract the generation of a permanent connection at the second side-gusseted tube corner, and in particular between the leaves of the first gusset, through a more even temperature and/or force distribution.

Against this background, it is also possible that, after the sealing tool, a knife or a similar separating element is inserted laterally into the first side gusset in order to immediately release certain adhesions.

Particularly, when a temperature gradient is to be generated in the manner described, a separating material and/or a material that affects thermal conductivity can be inserted into the corresponding side gusset as a strip or tape when in the flat state during heat sealing. Setting a temperature gradient in such a way that a permanent connection is only formed at the first side-gusseted tube corner when the first side-gusseted tube corner and the second side-gusseted tube corner lie one above the other, can lead to undesired adhesion of the material to the outside of the corresponding side gussets. Such adhesion can be reliably prevented by inserting a material in the region of the sealing tool. For example, a strip made of a suitable plastic such as polytetrafluoroethylene (PTFE) or sheet metal, for example, that is fixed in the region of the sealing tool or runs along in some regions can be provided.

Such a separating material also has an impact on heat conduction, wherein the additional material provides a certain degree of insulation and can also absorb some of the heat energy during the action of the sealing tool through its heat capacity.

To achieve a certain separation effect, additionally or alternatively, a separating coating, such as anti-sealing varnish, can be provided at the outer side.

The invention is explained below using solely exemplary embodiments.

In the drawings:

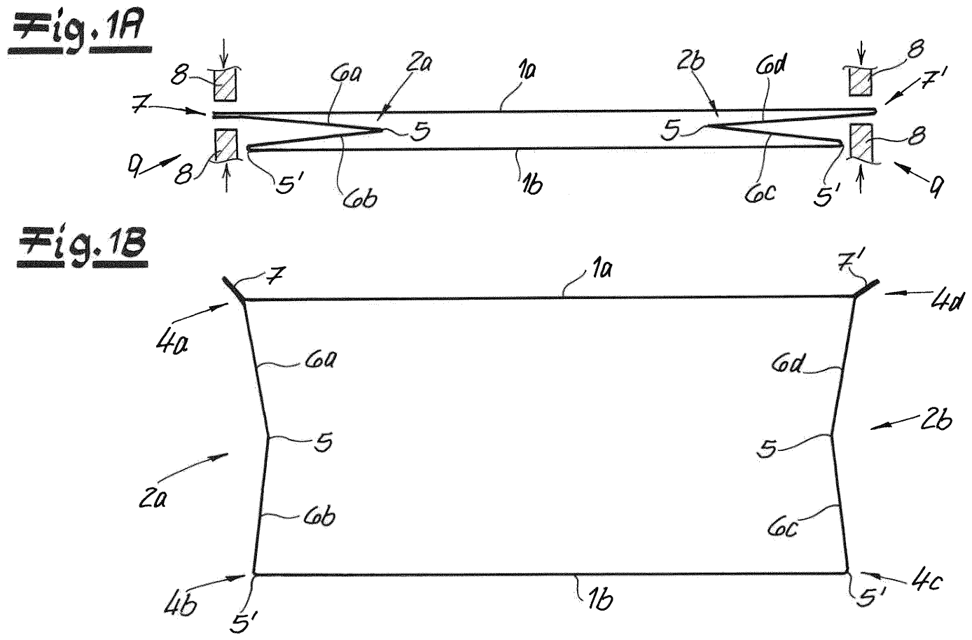

FIG. 1A shows a section through a side-gusseted hose during production of a first embodiment of a side-gusseted packaging bag according to the invention,

FIG. 1B shows a section through the side-gusseted packaging bag according to the first embodiment,

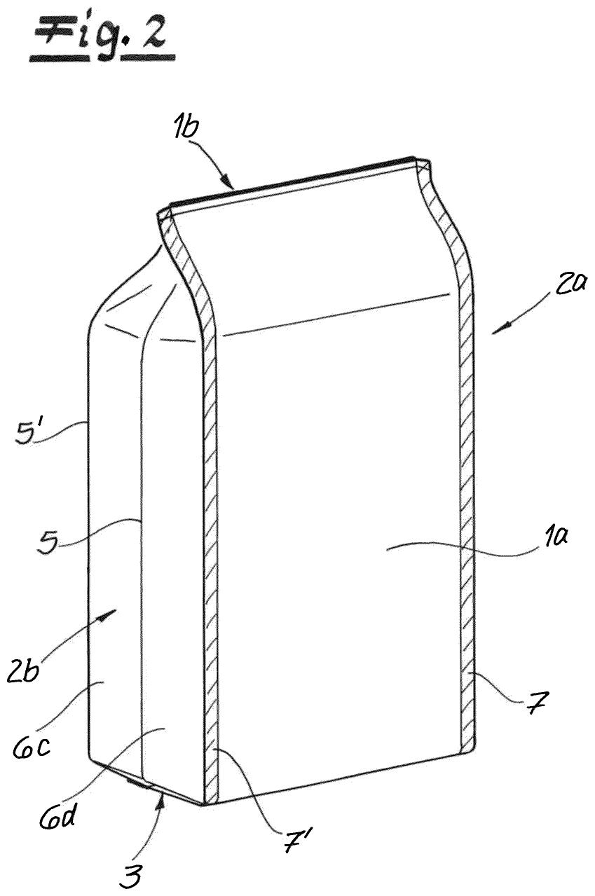

FIG. 2 shows the side-gusseted packaging bag according to the first embodiment in a perspective view,

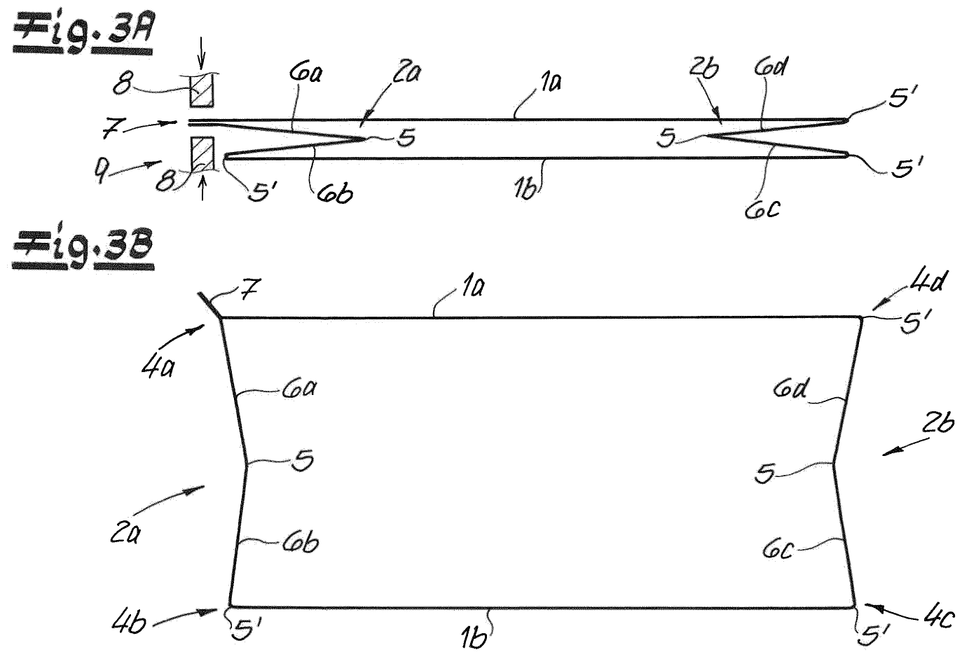

FIGS. 3A and 3B show views according to FIGS. 1A and 1B for a second embodiment of the invention,

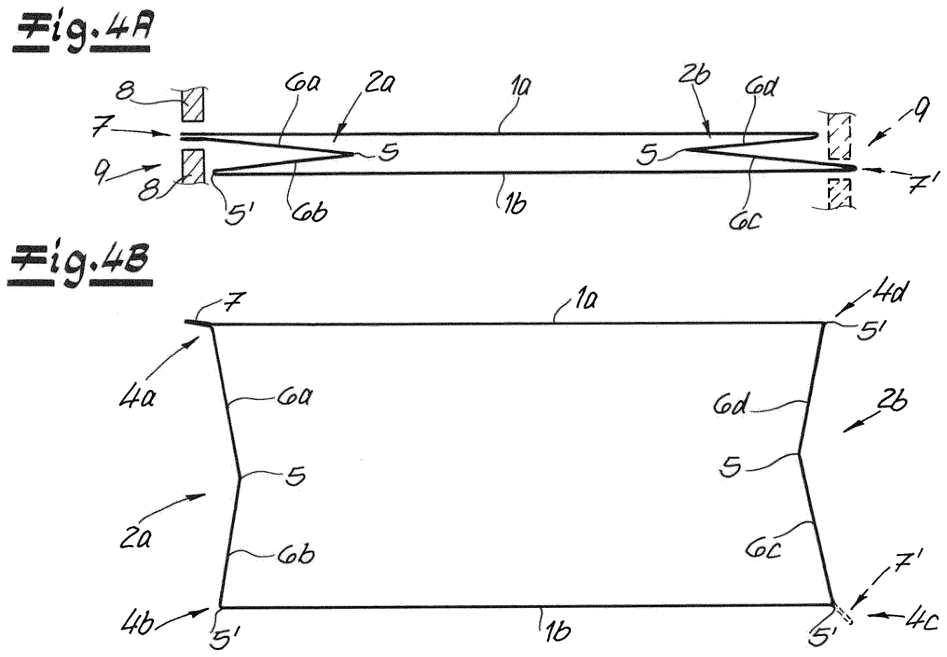

FIGS. 4A and 4B show views corresponding to FIGS. 1A and 1B for a third embodiment of the invention,

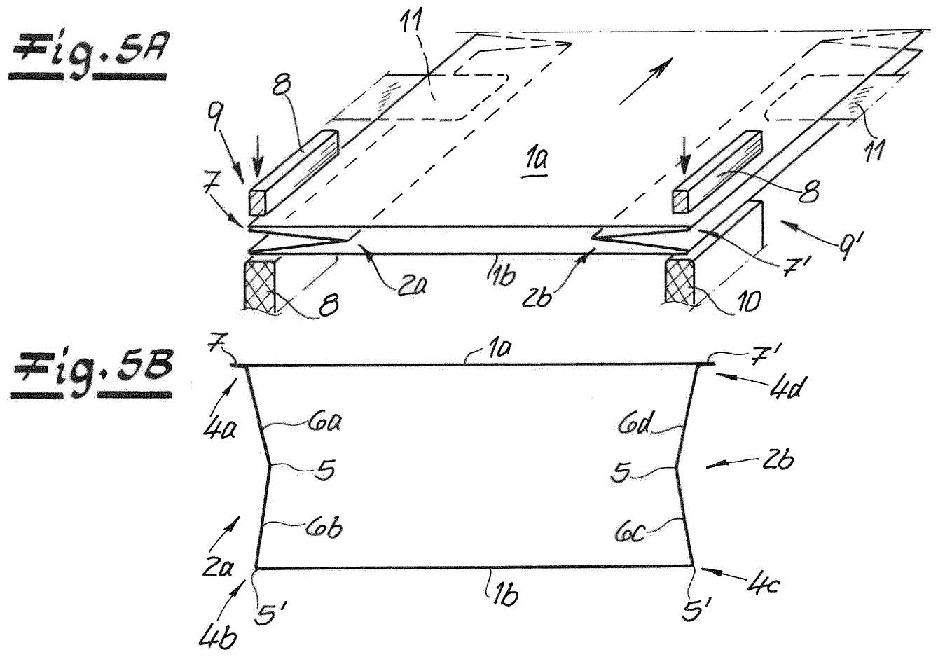

FIGS. 5A and 5B show views according to FIGS. 1A and 1B for a fourth embodiment of the invention,

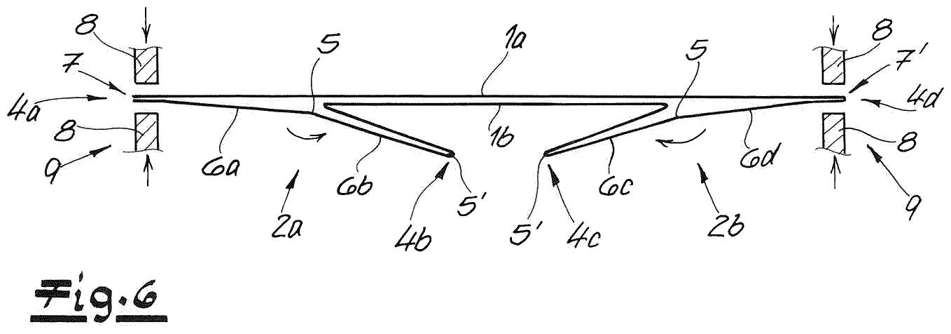

FIG. 6 shows a sectional illustration of a side-gusseted hose in a further embodiment of the invention.

FIG. 1A shows a sectional illustration of a side-gusseted tube for forming a side-gusseted packaging bag in a flat state. A section through the closed side-gusseted packaging bag is shown in FIG. 1B. FIG. 2 shows the side-gusseted packaging bag in a perspective view.

The side-gusseted tube and the side-gusseted packaging bag have a first front wall 1a, a second front wall 1b, a first side gusset 2a, and a second side gusset 2b, which, in the side-gusseted packaging bag according to FIG. 2, form a bag body, which is closed both circumferentially and at an upper end and a lower end. According to FIG. 2, the side-gusseted packaging bag is formed with a stand-up base 3.

The bag body has a total of four bag corners 4a, 4b, 4c, 4d, with side gussets 2a, 2b each having a folding line 5. Folding lines 5 represent a transition from a first leaf 6a to a second leaf 6b on first side gusset 2a, and a transition from a third leaf 6c to a fourth leaf 6d on second side gusset 2b. In the illustrated exemplary embodiment, bag corners 4a, 4b, 4c, 4d and leaves 6a, 6b, 6c, 6d are counted counterclockwise by way of example and without limitation.

From FIG. 1A it is apparent that front walls 1a, 1b and side gussets 2a, 2b are formed jointly by folding and sealing a web of the bag film.

The bag film consists of single-type polyolefin, in particular polyethylene, and is formed by extrusion, for example, as a monofilm. The bag film can be formed, for example, by extruding a blown film tube and blocking the blown film tube. The bag film therefore has the same material and also has the same sealing properties on both sides. If, contrary to FIG. 1A, first bag corner 4a and second bag corner 4b lie exactly one above the other during manufacture from the side-gusseted tube, first leaf 6a and second leaf 6b would usually also be undesirably connected together during usual heat sealing.

To avoid this, according to the exemplary embodiment of FIG. 1A, it is provided that first front wall 1a has a greater width than second front wall 1b. First front wall 1a thus extends transversely beyond second front wall 1b, wherein, accordingly, first leaf 6a and fourth leaf 6d are wider than second and third leaves 6b, 6c.

In the flat state, first bag corner 4a lies next to second front wall 1b, with the overhang typically being between 5 mm and 20 mm, in particular between 7 mm and 15 mm. Due to the overhang, a longitudinal seal seam 7 can be generated on first bag corner 4a according to FIG. 1A using a sealing tool 9 having two heated sealing jaws 8, wherein seal seam 7 on the first bag corner 4a also represents a circumferential closure seam. Second front wall 1b, on the other hand, solely adjoins second leaf 6b at second bag corner 4b via a folding line 5′.

Solely one folding line 5′ is provided also on third bag corner 4c, while on fourth bag corner 4d, optionally, solely a folding line 5′ or—as shown in the exemplary embodiment—another longitudinal seal seam 7′ can be provided. Additional seal seam 7′ can be expedient for reasons of stability as well as for esthetic reasons.

FIGS. 3A and 3B show, corresponding to FIGS. 1A and 1B, a second embodiment of the invention, wherein first front wall 1a is again wider than second front wall 1b, but protrudes from second front wall 1b solely at first bag corner 4a. Accordingly, the longitudinal seal seam is formed solely at first bag corner 4a, while solely folding lines 5′ are provided at remaining bag corners 4b, 4c, 4d.

FIGS. 4A and 4B relate to a third embodiment of the invention, in which front walls 1a, 1b have the same width, but are arranged offset from one another in the side-gusseted tube. This is achieved by first leaf 6a and third leaf 6c having a greater width than second and fourth leaves 6b, 6d. As with the previously described configurations, the offset arrangement results in an offset at first bag corner 4a, so that the longitudinal seal seam 7 can be formed there in the form of a closure seam.

At third bag corner 4c, optionally, either solely a folding line 5′ or a longitudinal seal seam 7′ can be provided. This longitudinal seal seam 7′ and a corresponding sealing tool are shown in dashed lines in FIGS. 4A and 4B.

FIGS. 5A and 5B relate to a fourth embodiment of the invention, in which first bag corner 4a and second bag corner 4b lie exactly one above the other at first side gusset 2a, and third bag corner 4c and fourth bag corner 4d lie exactly one above the other at second side gusset 2b, and, accordingly, front walls 1a, 1b also have the same width and are arranged without any offset.

In order to nevertheless generate longitudinal seal seams 7, 7′ exclusively at first bag corner 4a and fourth bag corner 4d, modified sealing tools 9′ are provided. Sealing tools 9′ in each case have only one heated sealing jaw 8, wherein an unheated counter element 10 having a rubber coating is provided, which also has a greater width than heated sealing jaw 8. By means of modified sealing tool 9′, a temperature gradient is generated across the thickness of the side-gusseted tube, which, with a suitable temperature selection or temperature control, only effects a permanent connection at first bag corner 4a or side-gusseted tube corner and/or fourth bag corner 4d, while conventional folding lines 5′ remain at second bag corner 4b and third bag corner 4d. In particular, the temperature gradient is also set and maintained in such a way that respective leaves 6a, 6b, 6c, 6d at two side gussets 2a, 2b are not permanently connected together.

In this context, FIG. 5A also shows that, behind modified sealing tool 9′, a separating element 11 can also be inserted into side gussets 2a, 2b in order to immediately release certain adhesions.

It should be understood that, in FIG. 5a, at first bag corner 4a, longitudinal seal seam 7 necessary there for a circumferential closure can be generated solely with a single modified sealing tool 9′.

FIG. 6 shows a further embodiment of the invention, in which, during production, the second side-gusseted tube corner is guided by a deflection unit past a sealing tool 9 having heated sealing jaws 8 that creates the longitudinal seal seam. For this purpose, the second side-gusseted tube corner can be temporarily folded inward. The same applies to the third side-gusseted tube corner, if an additional longitudinal seal seam 7′ is to be generated on the opposite side of first front wall 1a.

1. A side-gusseted packaging bag comprising a bag body which comprises a first front wall, a second front wall, a first side gusset, and a second side gusset and which is made of a bag film, wherein a first leaf of the first side gusset adjoins the first front wall at a first bag corner, and a second leaf of the first side gusset adjoins the second front wall at a second bag corner, wherein a third leaf of the second side gusset adjoins the second front wall at a third bag corner, and a fourth leaf of the second side gusset adjoins the first front wall a fourth bag corner, and wherein the first front wall and the first leaf are connected together at the first bag corner via a longitudinal seal seam in the form of a closure seam, wherein the second front wall adjoins the second leaf at the second bag corner solely via a folding line.

2. The side-gusseted packaging bag according to claim 1, wherein the bag film comprises single-type polyolefin.

3. The side-gusseted packaging bag according to claim 1, wherein the bag film is formed from the same polymer on a first side, which forms an outer side of the bag body, and on a second side, which forms an inner side of the bag body, and has the same sealing properties.

4. The side-gusseted packaging bag according to claim 3, wherein the first side and the second side are formed from a single material by extrusion.

5. The side-gusseted packaging bag according to claim 4, wherein the bag film is a monofilm.

6. The side-gusseted packaging bag according to claim 1, wherein the bag film is an extrusion film.

7. The side-gusseted packaging bag according to claim 1, wherein the front walls and the side gussets are formed jointly by folding and sealing a web of the bag film.

8. The side-gusseted packaging bag according to claim 1, wherein in a flat state with side gussets folded between the front walls, the longitudinal seal seam is arranged at the first bag corner next to the second front wall.

9. The side-gusseted packaging bag according to claim 1, wherein the first front wall has a greater width than the second front wall.

10. The side-gusseted packaging bag according to claim 1, wherein the first front wall adjoins the fourth leaf at the fourth bag corner via a longitudinal seal seam.

11. The side-gusseted packaging bag according to claim 1, wherein the second front wall adjoins the third leaf at the third bag corner solely via a folding line.

12. The side-gusseted packaging bag according to claim 1, wherein the first leaf and the third leaf have a greater width than the second leaf and the fourth leaf.

13. The side-gusseted packaging bag according to claim 1, wherein the bag body is printed with a wash-off printing ink.

14. A method for producing a side-gusseted packaging bag according to claim 1, wherein, successively,
a bag film is formed solely from one type of material through an extrusion process,
a web of the bag film is folded into a side-gusseted tube having a first front wall, a second front wall, a first side gusset folded in between the front walls and a second side gusset folded in between the front walls in such a way that a first side of the bag film forms an outer side and a second side of the bag film forms an inner side of the side-gusseted tube and that edges of the web lie one above the other at a first side-gusseted tube corner and there the first front wall and the first side gusset are initially not connected, and
the side-gusseted tube is closed circumferentially at the first side-gusseted tube corner by a longitudinal seal seam connecting the edges, thus connecting the first front wall to the first side gusset, while, at a second side-gusseted tube corner, a transition from the first side gusset to the second front wall remains in the form of a folded edge.

15. The method according to claim 14, wherein the front walls on the side-gusseted tube are formed with different widths and/or are offset from one another in such a way that the longitudinal seal seam connecting the first side gusset and the first front wall is formed laterally next to the second front wall.

16. The method according to claim 14, wherein the second side-gusseted tube corner is guided by a deflection unit past a sealing tool generating the longitudinal seal seam.

17. The method according to claim 14, wherein when generating the longitudinal seal seam, the first side-gusseted tube corner and the second side-gusseted tube corner lie one above the other, wherein a sealing tool is used to generate a temperature gradient across a thickness of the side-gusseted tube, which temperature gradient only effects a permanent connection at the first side-gusseted tube corner.

18. The method according to claim 14, wherein the bag film is formed by extruding a blown film tube and blocking the blown film tube.
